(19) United States
(12) Patent Application Publication
(10) Pub. No.: US 2017/0033325 A1
(43) Pub. Date: Feb. 2, 2017

(54) RECHARGEABLE BATTERY INCLUDING MULTIPLE CASES

(71) Applicant: SAMSUNG SDI CO., LTD., Yongin-si (KR)

(72) Inventors: Min-Yeol HAN, Yongin-si (KR); Hae-Kwon YOON, Yongin-si (KR); Dae-Sik KIM, Yongin-si (KR); Ga-Eun YEO, Yongin-si (KR)

(21) Appl. No.: 14/973,811

(22) Filed: Dec. 18, 2015

(30) Foreign Application Priority Data
Jul. 28, 2015 (KR) 10-2015-0106439

(51) Int. Cl. H01M 2/02; H01M 2/10

(52) U.S. Cl. CPC H01M 2/0245; H01M 2/1072; H01M 2220/20

(57) ABSTRACT

A rechargeable battery includes a battery cell having an inner case housing an electrode assembly and a cap plate combined with the inner case, and an outer case housing the battery cell, the outer case including an upper case having an opening at a first side of the upper case, and a lower case having an opening at a side facing the opening of the upper case.

### CROSS-REFERENCE TO RELATED APPLICATION

Korean Patent Application No. 10-2015-0106439, filed on Jul. 28, 2015, in the Korean Intellectual Property Office, and entitled: “Rechargeable Battery Including Multiple Cases,” is incorporated by reference herein in its entirety.

### BACKGROUND

1. Field

The present disclosure relates to a rechargeable battery including multiple cases.

2. Description of the Related Art

A rechargeable battery differs from a primary battery in that it can be repeatedly charged and discharged, while the latter is incapable of being recharged. Low-capacity rechargeable batteries are used in small portable electronic devices, e.g., mobile phones, notebook computers, and camcorders, while high-capacity rechargeable batteries can be used as a power source for, e.g., driving motors of a hybrid vehicle, an electric vehicle, and the like. For example, when a large capacity rechargeable battery is used as a power source for driving a motor, a module type in which a plurality of unit batteries are electrically coupled may be used.

The above information disclosed in this Background section is only to enhance the understanding of the background of the disclosure, and therefore it may contain information that does not form the prior art that is already known in this country to a person of ordinary skill in the art.

### SUMMARY

An exemplary embodiment of the present disclosure provides a rechargeable battery including: a battery cell including an inner case housing an electrode assembly and a cap plate combined with the inner case; and an outer case housing the battery cell. The outer case includes an upper case having an opening at one side of the outer case and a lower case having an opening at a side facing the opening of the upper case.

The upper case may include a first connecting portion, a spiral groove that is formed to be unbroken with a predetermined height at an inner circumferential surface of an end portion at a side where an opening is formed.

The lower case may include a second connecting portion to be fastened with the first connecting portion, and a spiral groove having a shape corresponding to that of the first connecting portion and that is formed unbroken with a predetermined height at an outer circumferential surface of the end portion at a side where an opening is formed.

The upper case may include a third connecting portion, a spiral groove of which is formed unbroken at an entire inner circumferential surface.

The lower case may include a fourth connecting portion to be fastened with the third connecting portion, and a spiral groove having a shape corresponding to that of the third connecting portion and that is formed unbroken at an entire outer circumferential surface.

The opening of the lower case may be inserted into the opening of the upper case, and the outer case may include a region where a lateral side of the upper case overlaps a lateral side of the lower case.

A maximum height of the overlapped region may be 30% to 100% of the maximum height of the outer case.

A thickness of the outer case may be 1 to 10 times that of the inner case.

A thickness of a lateral side of the outer case may be 1 to 10 times that of the inner case, and a thickness of a bottom or top surface of the outer case may be at least 2 times that of a lateral side of the outer case.

Strength of the outer case may be 1.1 to 10 times that of the inner case.

In the present disclosure, the outer case and the inner case may be formed of different materials.

An elastic force of the outer case may be 1.1 to 2 times that of the inner case.

A maximum width of a cross-section perpendicular to a length direction of the outer case may be 1.0 to 1.5 times the width when the rechargeable battery is not expanded by an increase in internal pressure.

### BRIEF DESCRIPTION OF THE DRAWINGS

Features will become apparent to those of skill in the art by describing in detail exemplary embodiments with reference to the attached drawings, in which:

FIG. 1 illustrates an exploded perspective view of a rechargeable battery according to an exemplary embodiment of the present disclosure.

FIG. 2 illustrates a cut-away perspective view of a battery cell according to the exemplary embodiment of the present disclosure.

FIG. 3 illustrates a cut-away perspective view of a battery cell according to another exemplary embodiment of the present disclosure.

FIGS. 4, 6, 8, and 10 illustrate exploded perspective views of outer cases according to various exemplary embodiments of the present disclosure.

FIGS. 5, 7, 9, and 11 respectively illustrate cross-sectional views of FIGS. 4, 6, 8, and 10.

FIGS. 12 and 13 illustrate cross-sectional views of outer cases according to various exemplary embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or element, or intervening layers or elements may also be present. In addition, it will also be understood that when a layer or element is referred to as being “between” two layers or elements, it can be the only layer or element between the two layers or elements, or one or more intervening layers or elements may also be present. Like reference numerals refer to like elements throughout.

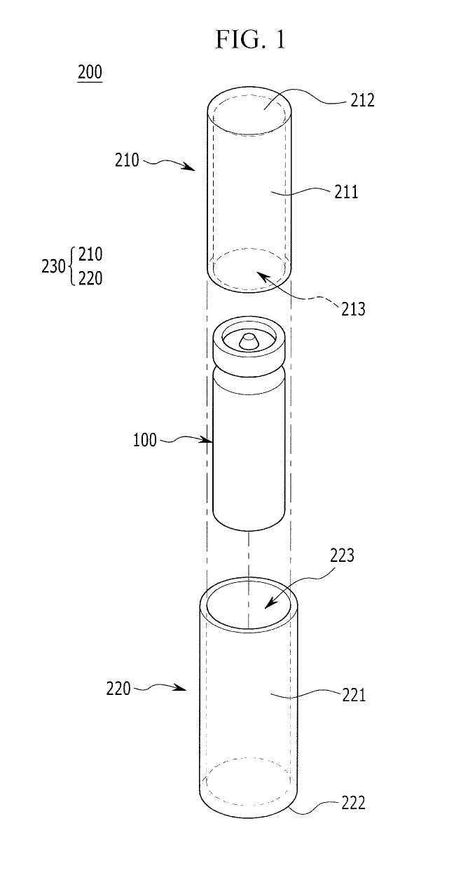

FIG. 1 is an exploded perspective view of a rechargeable battery according to an exemplary embodiment of the present disclosure.

Referring to FIG. 1, a rechargeable battery 200 according to the exemplary embodiment of the present disclosure may include a battery cell 100 and an outer case 230 that houses the battery cell 100. In this case, the outer case 230 may include an upper case 210 having an opening 213, and a lower case 220 having an opening 223 at a side facing the opening 213 of the upper case 210.

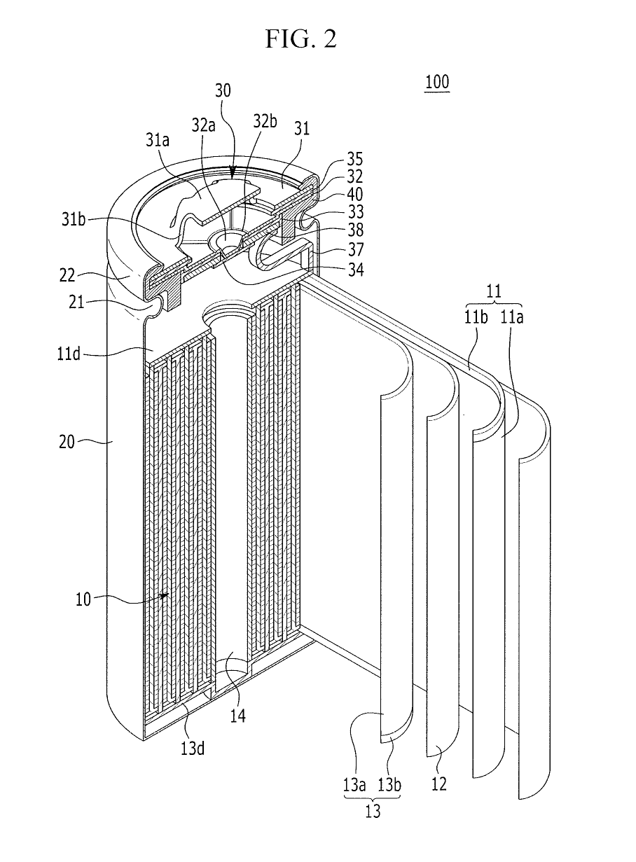

FIG. 2 is a cut-away perspective view of the battery cell 100.

Referring to FIG. 2, the battery cell 100 according to the exemplary embodiment of the present disclosure may include an electrode assembly 10 that generates current, an inner case 20 that houses the electrode assembly 10, and a cap plate 31 that is combined with the inner case 20 to seal the inner case 20.

As illustrated in FIG. 2, the electrode assembly 10 may includes a first electrode 11 (hereinafter referred to as a “positive electrode”), a separator 12, and a second electrode 13 (hereinafter referred to as a “negative electrode”) that are sequentially arranged. In addition, the electrode assembly 10 may be formed by winding the positive electrode 11, the negative electrode 13, and the separator 12 interposed therebetween as an insulator.

As an example, the electrode assembly 10 may be cylindrically formed. A core pin 14 may be disposed at a center of the cylindrical electrode assembly 10. The core pin 14 may have a cylindrical shape, and may support the electrode assembly 10 such that the electrode assembly 10 maintains its cylindrical shape.

Though not illustrated, as another example, an electrode assembly may have a prismatic shape. In this case, a flat-shaped electrode assembly may be manufactured by applying pressure to a cylindrically wound electrode assembly.

Meanwhile, the positive electrode 11 and the negative electrode 12 include coated regions 11a and 13a where an active material is coated on a current collector formed of a thin metal foil, and uncoated regions 11b and 13b where the active material is not coated thereon. A positive electrode current collecting plate 11d is connected to the uncoated region 11b of the positive electrode 11, and the positive electrode current collecting plate 11d is disposed at an upper end of the electrode assembly 10. A negative electrode current collecting plate 13d is connected to the uncoated region 12b of the negative electrode 13, and the negative electrode current collecting plate 13d is disposed at a lower end of the electrode assembly 10 to be attached to a bottom of the inner case 20 by welding.

The present exemplary embodiment illustrates a structure in which the positive electrode current collecting plate 11d is provided at the upper end while the negative electrode current collecting plate 13d is provided at the lower end, but the present disclosure is not limited thereto. For example, the positive electrode current collecting plate 11d may be provided at the lower end while the negative electrode current collecting plate 13d may be provided at the upper end.

The inner case 20 may have a cylindrical or prismatic shape with one side opened. The inner case 20 is coupled to the negative electrode current collecting plate 13d to act as a negative terminal in the battery cell 100, and is formed of a conductive metal, e.g., aluminum, an aluminum alloy, or nickel-plated steel.

In the current exemplary embodiment of the present disclosure, the cap plate 31 is included in a cap assembly 30, and is coupled to the opened side of the inner case 20 while interposing a gasket 40 therebetween, thereby closing and sealing the inner case 20 that houses the electrode assembly 10 and an electrolyte solution. The cap assembly 30 may include a vent plate 32, an insulating plate 33, a sub-plate 34, a positive temperature coefficient (PTC) element 35, and a middle plate 38 in addition to the cap plate 31. In this case, the cap assembly 30 may include a current interrupt device (CID), and is electrically coupled to the electrode assembly 10 via the CID.

In the battery cell 100 according to the current exemplary embodiment of the present disclosure, the cap plate 31 is formed as a plate where an outer terminal 31a protruding upward of the inner case 20 and an exhaust hole 31b opened at a lateral side of the outer terminal 31a are formed. In addition, the cap plate 31 is finally electrically coupled to the positive electrode current collecting plate 11d, and acts as a positive electrode terminal in the battery cell 100.

Substantially, the CID is formed by the vent plate 32 and the sub-plate 34, and a connecting portion of the CID is formed by welding the vent plate 32 and the sub-plate 34. The vent plate 32 forming one side of the CID is provided at an inner side of the cap plate 31, and is electrically coupled to the sub-plate 34 that forms the other side of the CID. In addition, the vent plate 32 includes a vent 32a that is ruptured under a predetermined pressure condition to discharge a gas inside the battery cell 100 and to cut off electrical connection with the sub-plate 34.

When the CID is operated, i.e., when the vent 32a is ruptured to cause the connecting portion of the vent plate 32 and the sub-plate 34 to be separated, the electrode assembly 10 and the cap plate 31 are electrically separated. For example, the vent 32a is formed in the vent plate 32 to protrude inward of the inner case 20. The vent plate 32 includes a notch 32b around the vent 32a that guides rupture of the vent 32a. When pressure increases by gas generated inside the case 20, the notch 32b is ruptured to discharge the gas to prevent the battery cell 100 from exploding.

The PTC element 35 is provided between the cap plate 31 and the vent plate 32, and controls a current flow between the cap plate 31 and the vent plate 32. Under a condition where the temperature exceeds a predetermined level, the PTC element 35 has electrical resistance that increases to infinity, and as a result, serves to cut off a flow of a charging or discharging current.

The sub-plate 34 faces the vent plate 32 while interposing the insulating plate 33 therebetween, and is electrically coupled to the vent 32a. The middle plate 38 is disposed between the insulating plate 33 and the sub-plate 34. The vent 32a protruding via through-holes of the insulating plate 33 and the middle plate 38 is connected to the sub-plate 34. Accordingly, a first side of the middle plate 38 is electrically coupled to the vent plate 32 via the sub-plate 34 and the vent 32a. and a second side thereof is coupled to the positive electrode current collecting plate 11d via a lead member 37. As a result, the positive electrode current collecting plate 11d is electrically coupled to the cap plate 31 via the lead member 37, the middle plate 38, the sub-plate 34, the vent 32a, the vent plate 32, and the PTC element 35.

The cap assembly 30 formed as described above is inserted into the case 20, and is then fixed to the case 20 via a clamping process, thereby completing the battery cell 100. At this time, a beading portion 21 and a clamping portion 22 are formed.

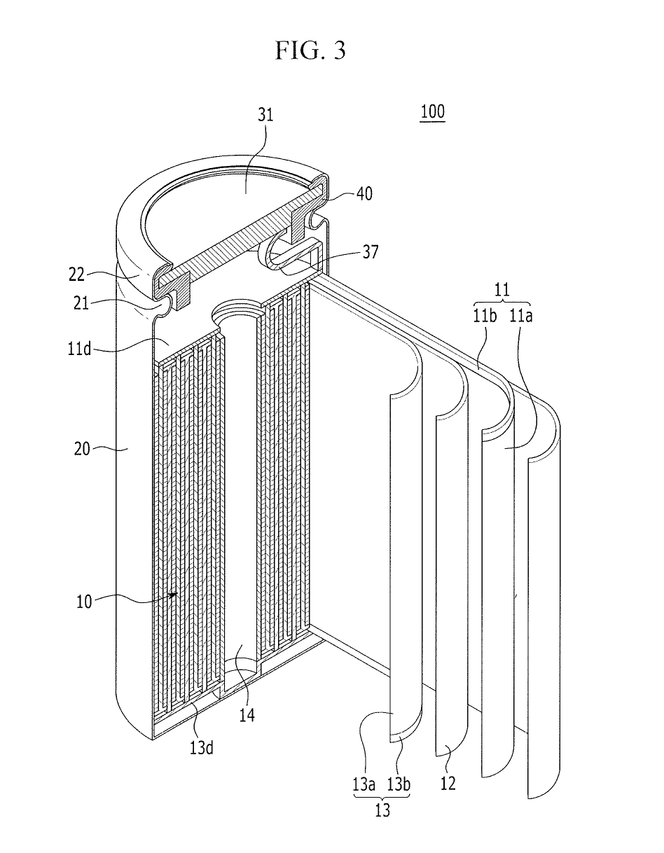

FIG. 3 is a cut-away perspective view of a battery cell according to another exemplary embodiment of the present disclosure.

Referring to FIG. 3, a battery cell 100 according to another exemplary embodiment of the present disclosure has the same structure as the battery cell 100 described above with reference to FIG. 2, except that it includes a cap plate 31 having a different shape instead of the cap assembly, and a duplicate description of the same structure will be omitted.

More specifically, the battery cell 100 according to FIG. 3 does not include a vent. Accordingly, the cap plate 31 is formed as a circular plate, and is combined to an opened side of an inner case 20 while interposing a gasket 40 therebetween, thereby closing and sealing the inner case 20 that houses the electrode assembly 10 and an electrolyte solution. In addition, a lead member 37 is coupled to a lower part of the cap plate 31 and is finally electrically coupled to a positive electrode current collecting plate 11d, so it may act as a positive electrode terminal in the battery cell 100.

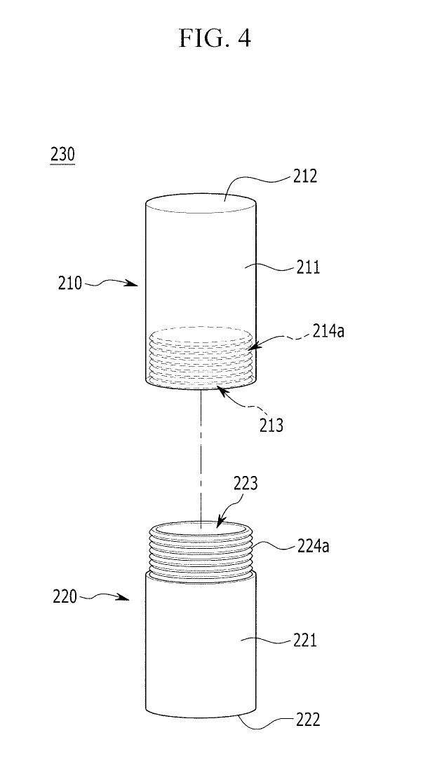

Referring back to FIG. 1, the battery cell 100 configured as described above is accommodated in the outer case 230, and the rechargeable battery 200 according to the present disclosure includes at least two cases. That is, the outer case 230 is configured by a combination of the upper and lower cases 210 and 220, such that the battery cell 100 of the rechargeable battery 200 is accommodated in the upper and lower cases 210 and 220 of the outer case 230, as will be described in more detail below with reference to FIGS. 4-13.

When the rechargeable battery 200 is accommodated in the outer case 230, it is desirable to completely seal between the inner case 20 and the outer case 230, e.g., a predetermined space may be included therebetween if necessary. When completely sealing between the inner case 20 and the outer case 230, even if an arc is generated inside the battery cell 100, an additional explosion may be easily prevented even without including an additional member, since a path through which external air is introduced into the battery cell 100 is blocked.

Alternatively, when the predetermined space is included between the inner case 20 and the outer case 230, the same effect as described above may be achieved by filling and sealing the space with a material that prevents oxygen from being introduced into the battery cell 100, e.g., sand, baking soda, fire-extinguishing powder, etc.

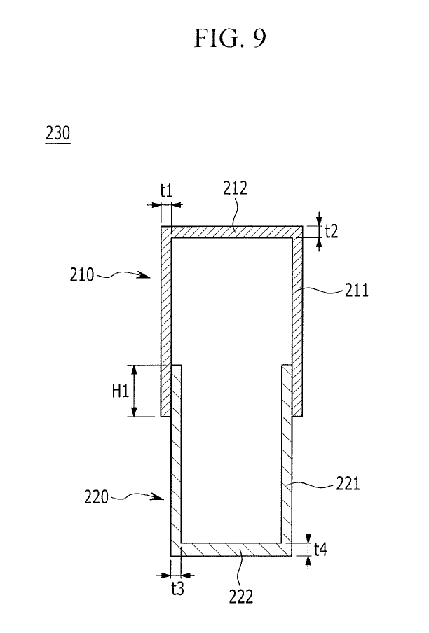

A total thickness of the outer case 230 may be about 1 to about 10 times that of the inner case 20. Since the total thickness of the outer case 230 is thicker, an arc generated inside the battery cell 100, i.e., a first explosion, may be completed within the outer case 230. It is noted that in regions where the outer case 230 includes overlapping portions of the upper and lower cases 210 and 220, as will be disused in detail below, the total thickness refers to a combined thickness of the overlapping portions, e.g., combined thickness of t1 and t3 in FIG. 9.

However, when the battery cell 100 includes the vent 32a as described above, a total thickness of a lateral side of the outer case 230 may be approximately about 1 to about 10 times that of the inner case 20, e.g., and a thickness of a bottom side 222 (t4 in FIG. 9) or a top side 212 (t2 in FIG. 9) of the outer case 230 may be approximately about 2 to about 10 times that of the lateral side of the outer case 230. When the vent 32a is included, a minimal amount of air may be introduced into the battery cell 100 since internal pressure and temperature of the battery cell 100 increase to cause the vent 32a to rupture. Thus, as a safety measure, it is desirable for the thicknesses of the bottom side 222 and the top side 212 of the outer case 230 to be at least 2 times the thickness of the lateral surface.

In the current exemplary embodiment of the present disclosure, strength (i.e., material strength) of the outer case 230 may be about 1.1 to about 10 times that of the inner case 20. In this case, the strengths of the outer case 230 and the inner case 20 may be measured by a strength measurement method that is generally used by those skilled in the art, but they are not specifically limited thereto. However, when the strength of the outer case 230 satisfies a range of about 1.1 to about 10 times that of the inner case 20, even if the first explosion due to the arc occurs in the battery cell 100 as intended by the present disclosure, the explosion is completed within the outer case 230 having excellent strength, and inflow of external oxygen may be prevented. Accordingly, since the first small explosion as described above is prevented from causing large explosions, e.g., additional second and third explosions, stability of the rechargeable battery may be dramatically improved.

On the other hand, in another exemplary embodiment of the present disclosure, an elastic force (i.e., elasticity) of the outer case 230 may be about 1.1 to about 2 times that of the inner case 20. In this instance, the elastic forces of the outer and inner cases may be measured by an elastic force-measuring method that is generally used by those skilled in the art, but they are not specifically limited thereto. However, when the elastic force of the outer case 230 satisfies a range of about 1.1 to about 2 times the elastic force of the inner case 20, even if the first explosion due to the arc occurs in the battery cell 100 as intended by the present disclosure, inflow of external oxygen is prevented, and the battery's external appearance only swells but is not structurally damaged since the outer case 230 has excellent elastic force. Accordingly, since the first small explosion as described above is prevented from causing large explosions, e.g., second and third explosions, stability of the rechargeable battery may be dramatically improved.

In this case, materials for forming the outer case 230 and/or the inner case 20 may be metal materials, e.g., aluminum, stainless steel, iron, tungsten, and alloys of these metals, and non-metal materials, e.g., a flame retardant silicon, polypropylene, Teflon®, glass fiber, a flame retardant resin, etc., but it is not limited thereto. In the case of the non-metal material, the materials described above may be applicable in the form of an insulating tape, a film, and the like.

In addition, the outer case 230 and the inner case 20 may be formed of different materials. For example, the inner case 20 may be formed of a metal material, e.g., aluminum or the like, while the outer case 230 may be formed of a flame retardant resin or the like.

For example, when the inner case 20 is formed of a metal material, the inner case 20 may be formed using, e.g., aluminum by a method such as deep drawing, forming, etc. to house the electrode assembly 10. In another example, when the outer case is formed of a non-metal material, e.g., a flame retardant resin that is manufactured as a film and is then formed as the outer case 230 having a predetermined shape to house the inner case 20, or as an insulating tape that is used to wrap around an outer surface of the inner case 20, thereby obtaining the rechargeable battery including the multiple cases. In yet another example, the outer case and the inner case may also be formed of the same material.

In addition, as described above in the present disclosure, contents of the materials for forming the case described above may be appropriately adjusted to manufacture an alloy or the materials may be mixed, thereby obtaining the outer case having excellent strength and/or elastic force.

FIGS. 4 to 13 illustrate various examples of the outer case 230 according to the present disclosure.

As described above, the outer case 230 includes the upper case 210 having the opening 213 at one side, and the lower case 220 having the opening 223 at the side that faces the opening 213 of the upper case 210. For example, the upper and lower cases 210 and 220 may be inserted into each other, such that the battery cell 100 is enclosed by the upper and lower cases 210 and 220.

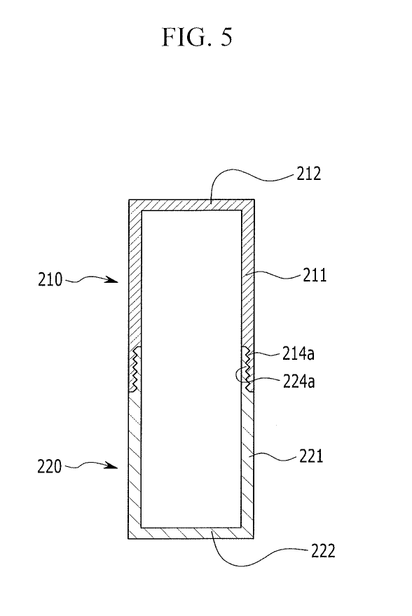

FIG. 4 illustrates one example of the outer case 230, and FIG. 5 is a cross-sectional view of FIG. 4.

Referring to FIGS. 4 and 5, the upper case 210 may include a first connecting portion 214a that is formed with a predetermined height at an inner circumferential surface of an end portion where the opening 213 is formed. The first connecting portion 214a has a shape in which a spiral groove is screw-processed along the inner circumferential surface of the upper case 210, and is combined with a second connecting portion to be described later, thereby configuring the outer case 230 by combining the upper case 210 with the lower case 220.

Accordingly, the lower case 220 may include a second connecting portion 224a that is formed with a predetermined height at an outer circumferential surface of an end portion where the opening 223 is formed. The second connecting portion 224a has a shape in which a spiral groove having a shape corresponding to that of the first connecting portion 214a is screw processed along the outer circumferential surface of the lower case 220, such that it is to be fastened with the first connecting portion 214a of the upper case 210.

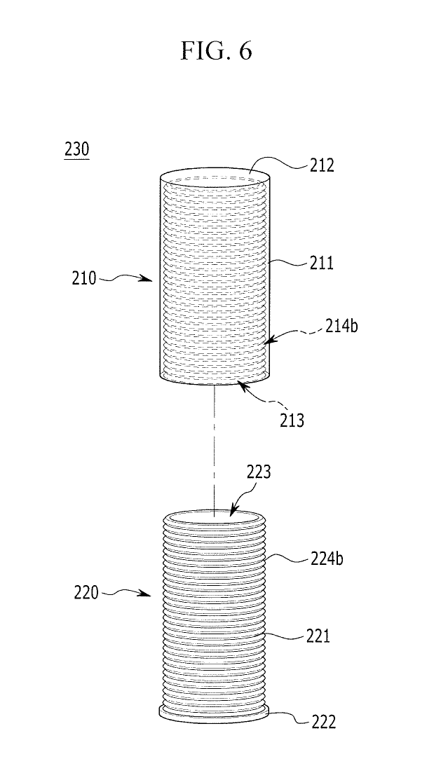

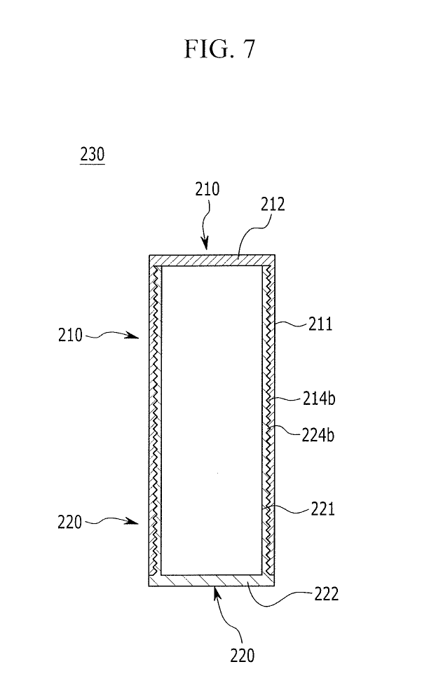

FIG. 6 illustrates another example of the outer case 230, and FIG. 7 is a cross-sectional view of FIG. 6.

Referring to FIGS. 6 and 7, the upper case 210 may include a third connecting portion 214b that is formed across an entire inner circumferential surface thereof. The third connecting portion 214b has a shape in which a spiral groove is screw processed along the inner circumferential surface of the upper case 210, and is rotated to be combined with a fourth connecting portion to be described later, thereby configuring the outer case 230 by combining the upper case 210 with the lower case 220.

Accordingly, the lower case 220 may include the fourth connecting portion 224b that is formed across an entire outer circumferential surface. The fourth connecting portion 224b has a shape in which a spiral groove having a shape corresponding to that of the third connecting portion 214b is screw processed along the outer circumferential surface of the lower case 220, such that it is to be fastened with the third connecting portion 214b.

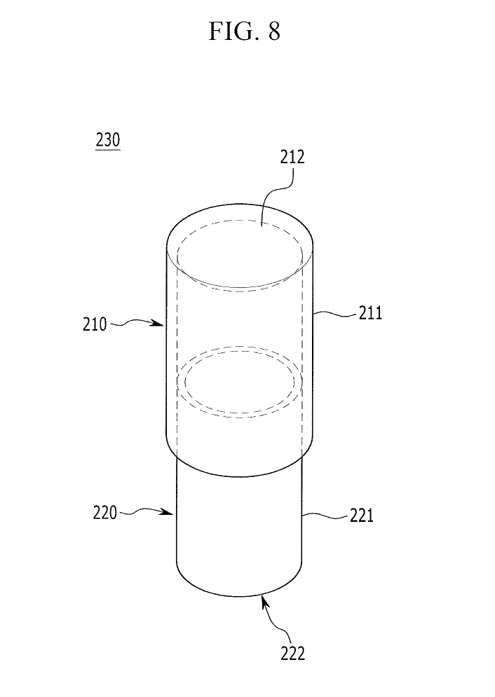

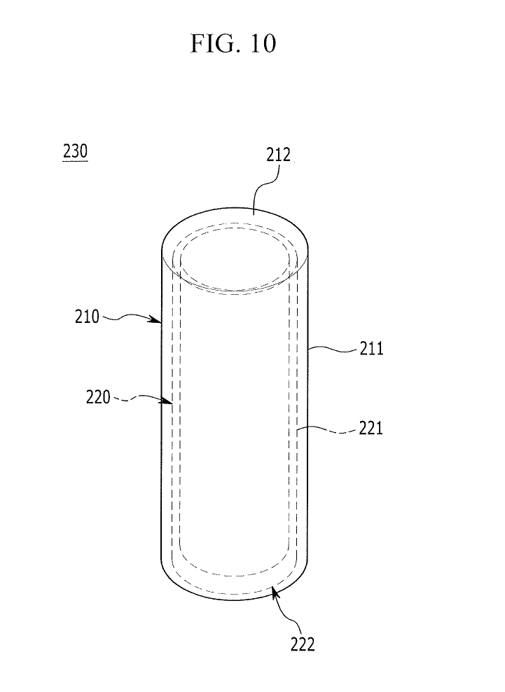

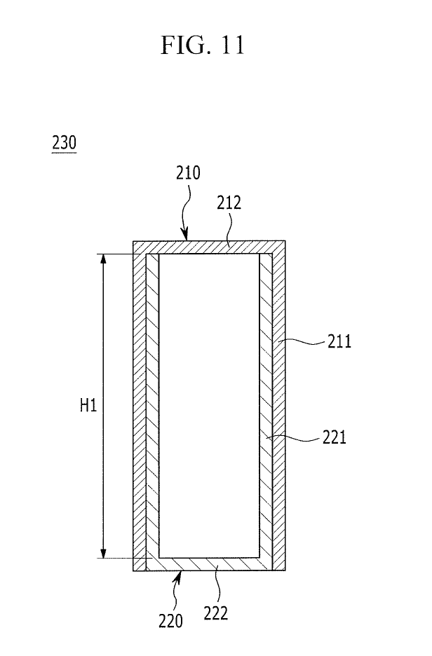

FIGS. 8 and 10 illustrate yet further examples of the outer case 230, and FIGS. 9 and 11 respectively illustrate cross-sectional views of FIGS. 8 and 10.

Referring to FIGS. 8 to 11, upper and lower cases may be combined such that an opening 213 of the upper case 210 is inserted into an opening 223 of the lower case 220, thereby configuring the outer case 230. Accordingly, the outer case 230 includes a region where a lateral side 211 of the upper case 210 overlaps at least a portion of a lateral side 221 of the lower case 220. In this case, a maximum height H1 of the region where the lateral side 211 of the upper case 210 overlaps the lateral side 221 of the lower case 220 may be about 30% to about 100% of the maximum height of the outer case 230. That is, the upper case 210 and the lower case 220, as shown in FIG. 9, may be formed such that their lateral surfaces partially overlap each other, or as shown in FIG. 11, their entire lateral surfaces overlap each other.

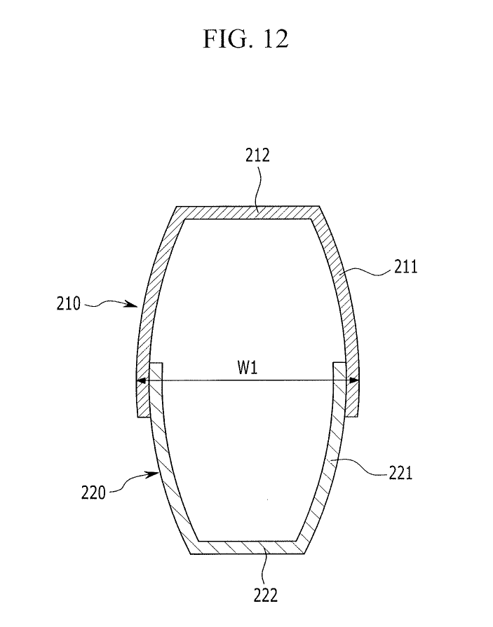

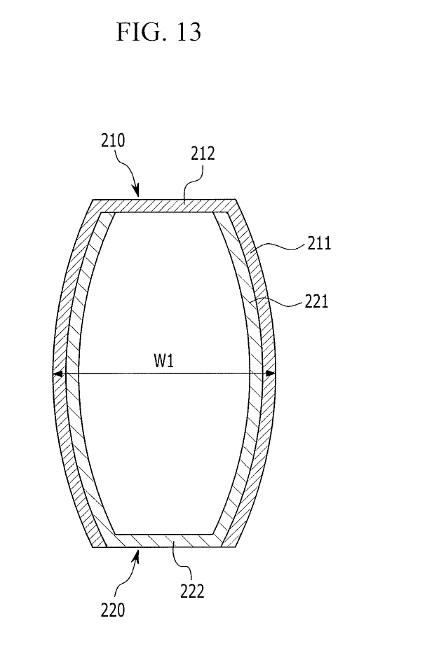

FIGS. 12 and 13 are cross-sectional views of yet further examples of the outer case 230.

Referring to FIGS. 12 and 13, the outer case 230 has excellent elastic force and thus swells even if internal pressure of the battery cell 100 increases due to overcharge and over-discharge, so when the battery cell 100 accommodated therein explodes, the outer case 230 may prevent such an explosion from propagating to the outside. In this case, since a maximum width W1 of a cross-section perpendicular to a length direction of the outer case 230 may increase as much as about 1.0 to about 1.5 times as compared to when the rechargeable battery does not expand due to increase in the internal pressure, a first explosion due to an arc generated in the battery cell is effectively prevented from causing a large second or third explosion.

As described above, in the rechargeable battery according to the present disclosure, since the battery cell including the inner case is housed inside an outer case that consists of multiple cases, e.g., the upper case and the lower case, even when the internal pressure of the rechargeable battery increases, a fire occurs only inside the battery cell due to the excellent strength and/or an expansion force of the outer case. Further, external air is blocked from being introduced inside the battery since the battery cell is housed in the multiple cases, thereby preventing second and third explosions in advance.

By way of summation and review, when a large capacity rechargeable battery is used as a power source for driving a motor, a module type in which a plurality of unit batteries are electrically coupled may be used. In such a large-capacity battery, if a large amount of current is present when a battery catches fire (e.g., due to overcharge and over-discharge), the heat should be discharged to the outside to avoid thermal runaway. If the heat is not discharged to the outside, the battery may be exposed to a risk of explosion, and in this case, a large explosion may occur when air is introduced into the battery, resulting in a major accident

In contrast, the present disclosure has been made in an effort to provide a rechargeable battery that is capable of having dramatically improved stability by including multiple battery cases. That is, in the rechargeable battery according to the present disclosure, stability of the rechargeable battery may be dramatically improved, even when a first explosion due to an arc associated with overcharge and over-discharge occurs inside the battery, by blocking external air from inflowing such that the first explosion does not cause second and third explosions leading to a major explosion.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable battery, comprising:
a battery cell including an inner case housing an electrode assembly and a cap plate combined with the inner case; and
an outer case housing the battery cell, the outer case including:
an upper case having an opening at a first side of the upper case, and
a lower case having an opening at a side facing the opening of the upper case.

2. The rechargeable battery as claimed in claim 1, wherein the upper case includes a first connecting portion at an end portion where the opening is formed, the first connecting portion including an unbroken spiral groove with a predetermined height at an inner circumferential surface of the end portion.

3. The rechargeable battery as claimed in claim 2, wherein the lower case includes a second connecting portion to be fastened with the first connecting portion, the second connecting portion including an unbroken spiral groove with a predetermined height and a shape corresponding to that of the spiral groove of the first connecting portion, the spiral groove of the second connecting portion being at an outer circumferential surface of an end portion at a side where the opening is formed.

4. The rechargeable battery as claimed in claim 1, wherein the upper case includes a third connecting portion, a spiral groove of which is unbroken along an entire inner circumferential surface.

5. The rechargeable battery as claimed in claim 4, wherein the lower case includes a fourth connecting portion to be fastened with the third connecting portion, the fourth connecting portion including a spiral groove having a shape corresponding to that of the third connecting portion and extending unbroken along an entire outer circumferential surface.

6. The rechargeable battery as claimed in claim 1, wherein the opening of the lower case is inserted into the opening of the upper case, and the outer case includes a region where a lateral side of the upper case overlaps a lateral side of the lower case.

7. The rechargeable battery as claimed in claim 6, wherein a maximum height of the overlapped region is about 30% to about 100% of a maximum height of the outer case.

8. The rechargeable battery as claimed in claim 1, wherein a total thickness of the outer case is about 1 to about 10 times that of the inner case.

9. The rechargeable battery as claimed in claim 1, wherein a thickness of a lateral side of the outer case is about 1 to about 10 times that of the inner case, and a thickness of a bottom or top surface of the outer case is at least 2 times that of a lateral side of the outer case.

10. The rechargeable battery as claimed in claim 1, wherein a strength of the outer case is about 1.1 to about 10 times that of the inner case.

11. The rechargeable battery as claimed in claim 1, wherein the outer case and the inner case include different materials.

12. The rechargeable battery as claimed in claim 1, wherein an elastic force of the outer case is about 1.1 to about 2 times that of the inner case.

13. The rechargeable battery as claimed in claim 12, wherein a maximum width of a cross-section perpendicular to a length direction of the outer case is about 1.0 to about 1.5 times the width when the rechargeable battery is not expanded by an increase in internal pressure.
